(19) United States
(12) Patent Application Publication
(10) Pub. No.: US 2016/0129812 A1
(43) Pub. Date: May 12, 2016

(54) INSULATING PROFILE, CONDUCTOR LINE AND METHOD FOR PRODUCING A CONDUCTOR LINE

(71) Applicant: CONDUCTIX-WAMPFLER GMBH, Weil am Rheim (DE)

(72) Inventor: Dieter SEIDEL, Steinen (DE)

(73) Assignee: CONDUCTIX-WAMPLER GMBH, Weil am Rhein (DE)

(21) Appl. No.: 14/894,562

(22) PCT Filed: Feb. 11, 2014
(86) PCT No.: PCT/EP2014/052661

§ 371 Date: Nov. 30, 2015

(30) Foreign Application Priority Data
Jul. 1, 2013 (DE) 10 2013 106 889.8

(51) Int. Cl. B60M 1/34; B60M 1/02

(52) U.S. Cl. CPC B60M 1/34; B60M 1/02

(57) ABSTRACT

An insulating profile having at least two profile legs extending in a longitudinal direction of the insulating profile and surrounding at least one receiving chamber for holding a bus bar, a conductor line having at least one insulating profile, and at least one electrically conductive busbar inserted therein. The receiving chamber has a mounting opening extending in the longitudinal direction. A method for producing a conductor line is also disclosed. The problem of enabling a simple and fast installation of a conductor line, even under difficult conditions, is addressed with an insulating profile in which an installation chamber arranged between the profile legs and having an introduction opening running in the longitudinal direction adjoins the receiving chamber. This problem is also addressed by a method including the steps of: a) inserting, pulling in or pushing in at least one busbar into at least one installation chamber; and b) pressing the busbar from the installation chamber into the receiving chamber.

The invention concerns an insulating profile for a conductor line according to the preamble of Claim 1, a conductor line according to the preamble of Claim 19, and a method for producing such a conductor line according to the preamble of Claim 23.

DE 71 15 690 U1 discloses a conductor line channel designed as a U profile, made of a nonconductive material, for an essentially strip-shaped busbar. The busbar is thereby inserted in such an upright manner into the conductor line channel that approximately half of the busbar looks out from the U profile. The protruding part of the busbar can then have a sliding contact with a current collector of the vehicle to be provided. Such an open, current-conducting busbar, under tension, must be absolutely prevented for the protection of persons and apparatuses.

DE 40 42 394 A1 concerns a busbar system with busbars that have a supporting housing and an insulation profile arranged in the housing in which the electrical conductors are kept. The conductors are thereby located in longitudinal ribs, which protect from direct contact and merely have very narrow, small slits for the introduction of the conductors into a hollow groove that is open downwards. Furthermore, the accessibility of the conductors there is prevented by a cover profile, which completely closes off the insulating profile toward the outside. The intrusion of a current collector contact of a conductor line system is not possible there.

EP 1 049 227 B1 concerns a distribution track with contact protection, wherein conductor elements there are stuck vertically into receiving chambers and protrude from the receiving chamber there, after the installation. The contact protection is thus ensured in that those conductors are covered on the side protruding outwards with an insulating profile made of nonconductive material, so that a direct contact is not possible. The electrical connection to current collectors placed locally is firm and unmovable by means of two pincer-shaped contacts facing each other, which are pushed over the insulating cover on the front of the conductors and then are in contact with the non-insulating electrical conductor in the back. A current collector contact of a conductor line, which can rub against the conductor arrangement cannot be used there.

DE 72 46 552 U concerns a flat profile with flat conductors, which is provided to supply stationary current collectors. There, electrically conducting flat conductors placed in an insulating material profile are inserted into a metal receiving chamber, so that the electrical flat conductors are insulated with respect to the metal receiving chamber. The electrical flat conductors are preferably produced there in one operation, together with the production of the flat profile—that is, they are not installed on-site. Rather, the entire insulating profile with the placed flat conductors has only to be inserted into the receiving chamber of the metal carrier profile. In order to facilitate the acceptance of the flat conductor in the insulating profile, the receiving chambers there have a funnel-shaped entry area. This has the disadvantage that the flat conductors must be inserted directly into the receiving chambers, since otherwise, as a result of the funnel shape open to the outside, they fall out of the insulating profile, especially with a vertically standing insulating profile or one suspended downward from above.

DE 40 05 069 A1 concerns a multiple-field switchgear with a busbar arrangement, wherein there, several busbars are firmly held in a prespecified position by a special installment arrangement, before they are finally inserted into the busbar carrier.

More recent conductor lines therefore provide for arranging the busbars completely in insulating profiles that merely have an opening for a sliding contact, for example, a carbon brush of a current collector, which extends in the longitudinal direction of the insulating profile. Thus, DE 10 2007 034 930 A1 discloses an insulating profile for a conductor line with a nonconductive basic body and an electrically conductive element firmly arranged on it. The basic body thereby has a hinge so that the conductive element can be arranged on two foldable parts of the basic body. The foldable parts are folded during the installation and inserted, folded, into a receiving body, so that the conductive elements will end up lying, protected against external access, between the foldable parts of the basic body. This construction is expensive, since the basic body of the insulating profile must always be connected with the busbar. Also, the installation is cumbersome, since the insulating profile with conductive elements must be folded and must be inserted, folded, in the receiving body.

Another problem with known insulating profiles is the installation on-site. With the known insulating profiles, the busbars are often introduced into the receiving chambers of the insulating profiles only on-site. Typically, the busbars are thereby supplied as strip material and pulled from the front side into the already installed insulating profile, often also over lengths of more than 10 meters and to some extent, even more than 100 meters. Since the tolerances of the receiving chambers for the firm placing of the busbars in the receiving chambers are relatively small, even smaller deviations of the busbars from the prespecified shape or slight soiling of the busbars or the receiving chambers result in the busbars tilting in the receiving chambers and a further pulling in of the busbars being blocked, in particular, with greater lengths. The error site must then be found on-site and reworked, which is expensive and time-consuming and is also often connected with a great expenditure of force. Since connector lines often have to be installed, however, on hall ceilings at heights of several meters, the installer has no possibility of pulling the busbar further by pulling hard. It is then necessary to carry out an expensive dismantling of the insulating profile.

Therefore, the goal of the invention is to create an insulating profile, a conductor line, and a method for producing such a conductor line, which overcome the aforementioned disadvantages and make possible a simple and quick installation of a conductor line, even under the difficult conditions.

The invention attains this goal with an insulating profile with the features of Claim 1, a conductor line with the features of Claim 19, and a method for producing a conductor line in accordance with Claim 23. Advantageous developments and appropriate refinements of the invention are indicated in the dependent claims.

An insulating profile mentioned in the beginning is characterized in accordance with the invention in that an installation chamber arranged between the profile legs, with an introduction opening running in the longitudinal direction, adjoins the receiving chamber.

In this way, the process of introducing and affixing the busbar can be subdivided into two steps—namely, the inserting of the busbar into the installation chamber, requiring less accuracy, and the subsequent pressing of the busbar from the installation chamber into the final, fixed position in the receiving chamber. Preferably, the busbar can thereby be formed in the shape of a strip with an essentially rectangular outer contour.

Preferably, holding means to hold the busbar in the receiving chamber can be provided between the receiving chamber and the installation chamber.

Furthermore, the holding means can be placed on at least one of the profile legs and preferably be directed toward the interior, so that additional affixing means need not be provided. The receiving chamber can thereby be advantageously formed between the profile legs, a profile bottom, and the holding means.

In an advantageous development, the holding means can be interrupted in the longitudinal direction, wherein the holding means can be placed on one or both profile legs. Holding means arranged advantageously on profile legs opposite one another can be placed in a longitudinal direction, staggered, relative to one another.

In an embodiment which is favorable with respect to installation technology, the holding means—as viewed from the installation chamber—can have at least one sliding surface that is inclined from the profile legs to the receiving chamber. In this way, the busbar can be more easily brought from the installation chamber into the receiving chamber.

Preferably, the holding means—as viewed from the receiving chamber—can have at least one holding surface protruding, essentially vertically, from the profile legs, so as to be able to hold the busbars firmly in the receiving chamber.

Advantageously, the holding means are shorter from the installation chamber toward the receiving chamber, so that busbars of different thicknesses can be inserted, according to need, into an insulating profile. In this way, it is possible to simply adapt the conductor line to different performance levels of the electrical energy transfer. For example, an existing conductor line can be simply modified in the case of already installed insulating profiles in accordance with the invention, in that only the busbars are replaced.

Preferably, the holding means and/or the insulating profile can be elastic, so that the holding means can yield when the busbar is pressed from the installation chamber into the receiving chamber or the profile legs, until the busbar sits in the receiving chamber.

Advantageously, holding projections can be provided on the profile legs in the area of the installation chamber, preferably in the area of the introduction opening, and preferably directed inward toward the receiving chamber. In this way, during the installation, the busbars can be held securely in the installation chamber.

Advantageously, the width of the receiving chamber can essentially correspond, or be slightly larger, relative to the width of the busbar and/or the height of the receiving chamber, essentially to the thickness of the busbar, in order to further improve the seat of the busbar in the receiving chamber.

Preferably, the height of the installation chamber can be smaller than the width of the busbar, preferably smaller than one-fourth, and with particular preference, smaller than one-half of the width of the busbar. In this way, the busbar can be located in a favorable, relatively steeply tilted pre-installation position in the installation chamber and the risk of an “overturning” of the busbar in the installation chamber can be reduced, so that the subsequent pressing into the receiving chamber can be simplified.

Preferably, the height of the installation chamber can be greater than the thickness of the busbar, preferably greater than one and one-half times, and with particular preference, greater than twice the thickness of the busbar. In this way, the busbar can be placed in a favorable, relatively steeply, but not excessively steeply tilted pre-installation position in the installation chamber, so that the subsequent pressing into the receiving chamber can be simplified.

Preferably, the insulating profile can have an essentially U-shaped cross-section.

In an advantageous embodiment, an insulating profile can have several receiving chambers, wherein in an advantageous refinement, at least one of the receiving chambers has a different form—in particular, an inner contour—than the other receiving chambers.

Preferably, the above and subsequently described insulating profiles can be used with conductor lines in which current collector contacts that are conducted along the insulating profiles mesh into the insulating profile(s) and can have a sliding contact with the individual busbars inserted into the insulating profiles. However, the insulating profiles can also be used advantageously in other applications, for example, as electrically conductive connections or a sliding tap of current collectors, for example, in illumination areas.

A conductor line mentioned in the beginning has an above and subsequently described insulating profile in accordance with the invention. Preferably, two or more insulating profiles in accordance with the invention are thereby preferably located next to one another. Also preferred, at least one receiving chamber can have a shape different from the other receiving chambers, wherein the busbars are adapted to the shape of the receiving chambers.

As an additional advantage, the busbar and the receiving chamber can be adapted to one another in their shape, outer contour, and/or cross-section for the insertion—with no risk of confusion—of the busbar into the receiving chamber. In an advantageous embodiment, the busbar can thereby be formed from a carrier layer and a sliding layer placed thereon, wherein the shape of the busbar and the receiving chamber are adapted to one another in such a way that the busbar can only be inserted into the receiving chamber with the sliding layer pointing to the installation opening and the introduction opening. Preferably, the shape in the cross-section or the outer contour is the form of a moon or sickle or V, wherein the concave or retracted side points to the installation opening.

A method mentioned in the beginning for the production of a conductor line in accordance with the invention is characterized, in accordance with the invention, by the following steps: a) inserting, pulling in, or pushing in of at least one busbar into at least one installation chamber, and b) pressing the busbar from the installation chamber into the receiving chamber.

Preferably, the pressing of busbar in step b) can be carried out by means of a pressing tool and/or by means of a sliding contact, in particular, a pressing sliding contact that is specially designed for the purpose, a current collector guided along the conductor line. In an embodiment that is favorable with respect to installation technology, at least two busbars can be simultaneously pressed into the individual receiving chamber with a conductor line with several insulating profiles and/or several receiving chambers per insulating profile in step b).

Other special features and advantages of the invention can be deduced from the following description of preferred embodiment examples with the aid of the drawings. The figures show the following:

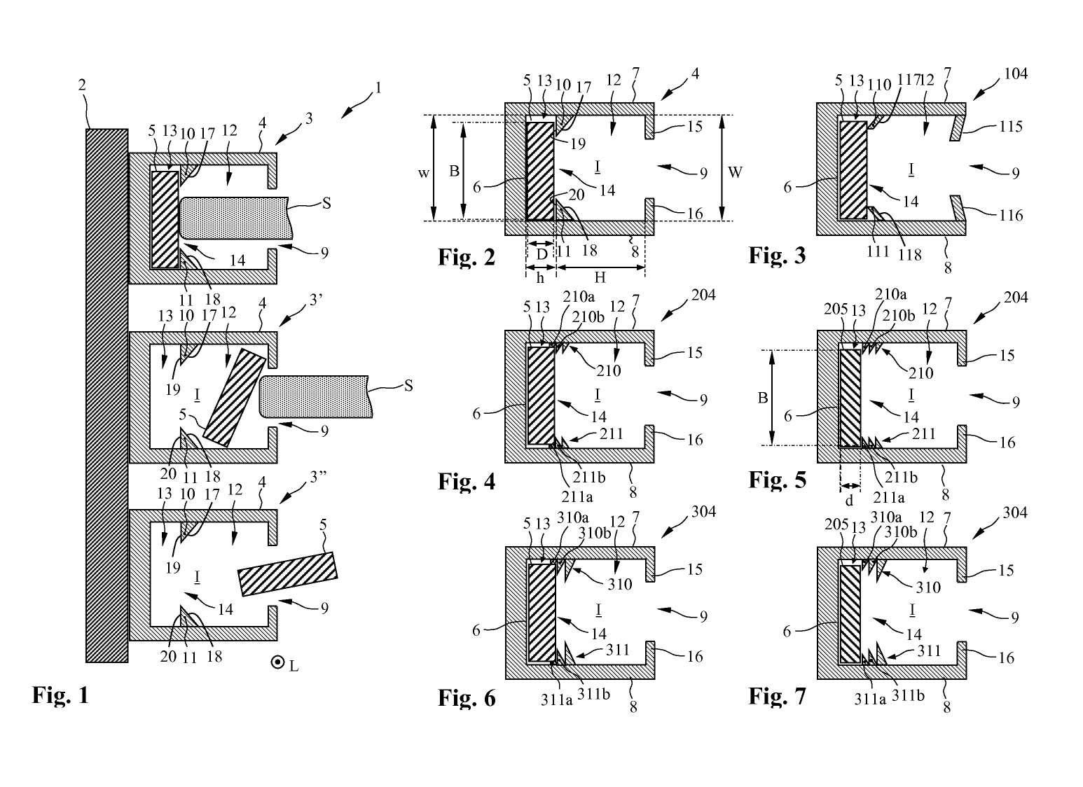

FIG. 1, a cross-section through a conductor line, in accordance with the invention, with three insulating profiles, in accordance with the invention;

FIG. 2, a cross-section through an insulating profile of the conductor line from FIG. 1, in accordance with the invention;

FIG. 3, a cross-section through an alternative insulating profile, in accordance with the invention;

FIG. 4, a cross-section through another alternative insulating profile, in accordance with the invention, with a thicker busbar;

FIG. 5, the cross-section through the insulating profile from FIG. 4 with a thinner busbar;

FIG. 6, a cross-section through another alternative insulating profile, in accordance with the invention, with a thicker busbar;

FIG. 7, the cross-section through the insulating profile from FIG. 6 with a thinner busbar;

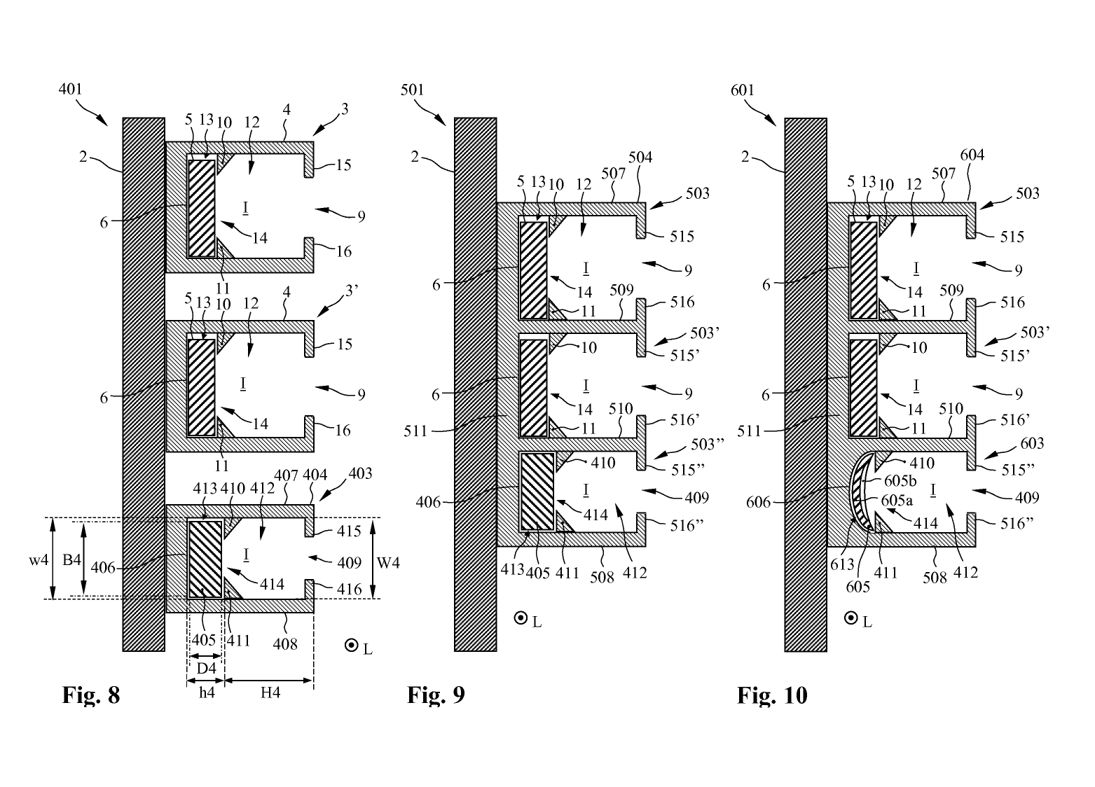

FIG. 8, a cross-section through an alternative embodiment of a conductor line, in accordance with the invention, with three insulating profiles, in accordance with the invention;

FIG. 9, a cross-section through another alternative embodiment of a conductor line, in accordance with the invention, with an alternative insulating profile, in accordance with the invention;

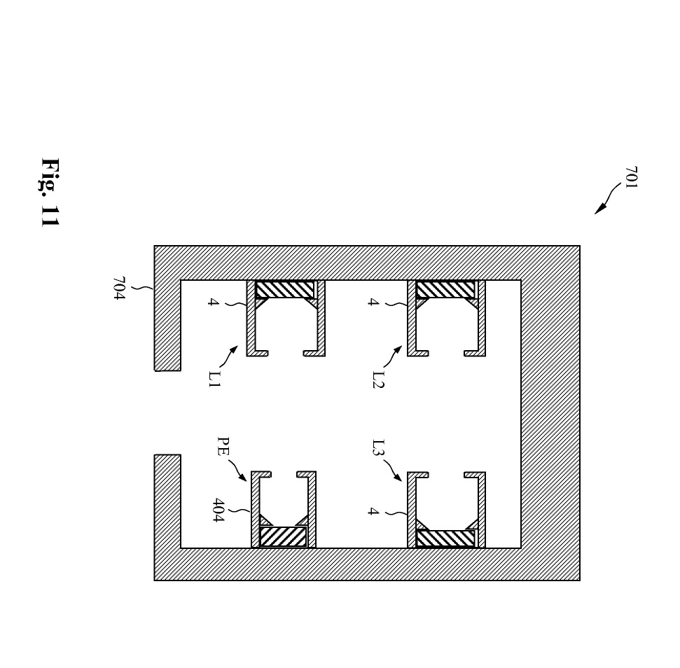

FIG. 10, a cross-section through an alternative embodiment of a conductor line, in accordance with the invention, with another alternative insulating profile, in accordance with the invention;

FIG. 11, a cross-section through another alternative embodiment of a conductor line, in accordance with the invention, with another alternative insulating profile, in accordance with the invention.

FIG. 1 shows a cross-section through a conductor line 1, in accordance with the invention, which is used to supply an electric consumer which can be moved along the conductor line 1.

The conductor line 1 and its basic structure and mode of functioning are, in fact, known so that more detailed statements in this regard are superfluous.

The conductor line 1 has three conductor strands 3, 3′, 3″, which are located on a carrying structure 2 and extend in a longitudinal direction L of the conductor line 1. The conductor strands 3, 3′, and 3″ are essentially formed by insulating profiles 4, in whose interior I, in the longitudinal direction L, strip-shaped, electrically conductive busbars 5 are inserted. The busbar 5 has the width B and the height H shown in FIG. 2. Since the insulating profiles 4 and the busbars 5 are designed identically in FIG. 1, they are uniformly marked in FIG. 1 with the same reference symbols. Therefore, later on, the invention is also described—to the extent possible—with the aid of the conductor strand 3; corresponding statements, however, are also valid for the other conductor strands 3′ and 3″.

The insulating profile 4 shown in detail in FIG. 2 is made of a nonconductive, preferably elastic or partially elastic material such as plastic and is placed, with a profile bottom 6, on the carrying structure 2. If necessary, the carrying structure 2 can also be produced, in one piece, with the insulating profiles 4. Also, depending on the electrical energy transfer requirement, more or fewer insulating profiles 4 can also be provided.

From the profile bottom 6 of the insulating profile 4, U-shaped profile legs 7, 8, which extend in the longitudinal direction L and are opposite one another, protrude toward an introduction opening 9 of the insulating profile 4. As can be seen above in FIG. 1, the introduction opening 9 is used in the operation of the sliding contact 1 so that, in a manner which is in fact known, an indicated sliding contact S of a current collector of the electrical consumer to be supplied can mesh into the insulating profile 4 and can make contact with the busbar 5 for the electrical energy transfer.

In the installation of the conductor line 1, on the other hand, the introduction opening 9 can be used to insert the busbar 5 into the insulating profile 4. Alternatively, the busbar 5 can also be pushed or pulled into the insulating profile 4 on the front side.

Since such conductor lines 1 often have great lengths, insulating profiles 4, 4′, and 4″ and busbars 5, 5′, and 5″ are usually supplied as wrapped-up strip material or bars cut to the maximum possible transportable length and put together only on-site. Problems often result hereby when inserting busbars 5, 5′, and 5″ into the insulating profiles 4, 4′, and 4″, since both easily warp with great lengths. Also, it may happen that busbars 5, 5′, and 5″, which have already been inserted into the insulating profiles 4, 4′, and 4″, again fall out, especially if the insulating profiles 4, 4′, and 4″ are installed upside down or laterally, as is shown in FIG. 1.

With the insulating profile 4, holding means are provided and designed as triangular locking lugs 10, 11, which, on the inside, are at a distance from one another on the profile legs 7, 8; they divide the interior of the insulating profile 4, surrounded by the profile bottom 6 and the profile legs 7, 8, into an installation chamber 12 with a width W and a height H and a receiving chamber 13 with a width w and a height h. Between the locking lugs 10, 11, an installation opening 14, extending in the longitudinal direction L of the insulating profile 4, is provided, so as to be able to insert the busbar 5 into the receiving chamber.

The installation chamber 12 is used to hold the busbar 5 when it is inserted in the insulating profile to the extent that it is held in a position favorable for the end installation in the receiving chamber 13. Advantageously, for this purpose, the profile legs 7, 8 have—on their free ends—holding projections 15, 16 that are directed toward the introduction opening 9 and that hold the busbar 5 in the position depicted in the middle of FIG. 1. In this way, the busbar 5 can be held in an approximate pre-installation position, which facilitates the subsequent, precisely located fixing of the busbar 5 in the receiving chamber 13.

The receiving chamber 13 with the width w and the height h and also the holding elements 10, 11 are designed in their dimensions in such a way that the strip-shaped busbar 5, which is essentially rectangular in its cross-section, is held with as flush a fit as possible therein. Therefore, even with a transit of the sliding contact S of the current collector, the busbar 5 cannot fall from the receiving chamber 12 or be dislodged from its position in the receiving chamber 12.

With the designs of the holding means as triangular locking lugs 10, 11, shown in FIGS. 1 and 2, the busbar 5 can be pushed from the installation chamber 12 by pressing in the direction of the receiving chamber 13 via the locking lugs 10, 11. The locking lugs 10, 11 yield thereby in a known manner, as a result of their elasticity and also the elasticity of the insulating profile 4, until the busbar 5 is on the profile bottom 6 and the holding surfaces, which extend parallel to the profile bottom 6 and are designed as locking surfaces 17, 18, snap over the busbar 5.

The alternative embodiment of an insulating profile 104, in accordance with the invention, which is shown in FIG. 3, essentially differs, due to the design of the holding means and the ends of the profile legs 6, 7, from the insulating profile 4 shown in FIGS. 1 and 2. The same reference symbols are therefore used for the same parts, and the statements regarding the insulating profile 4 are correspondingly valid.

The holding means with the insulating profile 104 are designed as locking bars 110, 111, which are inwardly directed from the profile legs 7, 8, at an incline, to the profile bottom 6 of the insulating profile 104. In this way, the locking bars 110, 111 can be simply bent when the busbar 5 is pressed, and after the busbar 5 is pressed into the receiving chamber 13, they are again moved elastically into their basic position, shown in FIG. 4, in which they resiliently press the busbar 5 against the profile bottom 6. The locking bars 110, 111 require little material and can be easily bent. Also, the locking bars 110 and 111 have sliding surfaces 117, 118 on the side of the installation chamber 12.

In the embodiment according to FIG. 3, the holding projections 115, 116, located on the free ends of the profile legs 7, 8, are slanted inwards toward the installation chamber 12 and the profile bottom 6, wherein the insertion of the busbar 5 is facilitated by the introduction opening 9 and the risk of the busbar 5 falling out of the installation chamber is further reduced.

The design of the holding projections 115, 116 can also be correspondingly used with the other embodiments described here and shown in the drawings.

Another alternative embodiment of an insulating profile 204, in accordance with the invention, shown in FIGS. 4 and 5, in turn, essentially differs from the insulating profile 4, due to the design of the holding means. For the same parts, therefore, the same reference symbols are used, and the statements regarding the insulating profiles 4 and 104 are correspondingly valid.

In the insulating profile 204, locking lugs 210, 211, arranged in the shape of sawteeth in the pressing direction of the busbar, are used as holding means; the lugs, in turn, have sliding surfaces on the side of the installation chamber 12 and locking surfaces, on the side of the receiving chamber 13. In this way, not only the busbar 5 with the thickness D, to which the receiving chamber 13 is adapted, can be inserted into the insulating profile 204. Rather, busbars with other thicknesses can also be inserted there, for example, the flatter busbar 205 with the thickness d and the width B, shown in FIG. 5.

The thicker busbar 5 ends up lying, as shown in FIG. 4, under the pair of opposite locking lugs 210b, 211b, in the middle of FIG. 4, whereas the lowermost pair of locking lugs 210a, 211a, seen from the profile bottom 6, are pressed together by the busbar 5. The flatter busbar 205, on the other hand, ends up lying, as shown in FIG. 5, under the pair of opposite locking lugs 210a, 211a which is the lowermost in FIG. 5.

Thus, in a simple manner, this embodiment makes possible the use of busbars 5, 205 with different thicknesses D and d, so that this simple adaptation of the electrically transferable power can take place, without having to replace the insulating profile 204. Depending on the number of locking lugs 210, 211, arranged in the shape of sawteeth, it is therefore possible to cover a wide range of busbars with different thicknesses. Thus, an existing conductor line 1 can be simply and quickly upgraded by replacing the busbars.

Another alternative embodiment of an insulating profile 304, in accordance with the invention and shown in FIGS. 6 and 7, is a modification of the insulating profile 204, shown in FIGS. 4 and 5, and, in turn, essentially differs from the insulating profile 204, due to the design of the holding means. For the same parts, therefore, the same reference symbols are used, and the statements regarding the insulating profile 204 are correspondingly valid.

In the insulating profile 304, in addition to the corresponding development in FIGS. 4 and 5, sawtooth-shaped locking lugs 310, 311 become shorter and shorter toward the profile bottom 6, so that the installation opening 14 widens toward the receiving chamber. In this way, the holding of busbars 5, 205 with different thicknesses in the receiving chamber 13 can be improved even more, in particular, for thicker busbars 5. A middle pair of locking lugs 310b, 311b, shown in FIG. 6, embraces the thicker busbar 5 more intensely than the corresponding pair of locking lugs 210b, 211b, shown in FIG. 4, so that the thicker busbar 5 is pressed even more firmly against the profile bottom and is held better in the receiving chamber 13.

The installation of the busbar 5 in the insulating profile is now described in detail—for reasons of a simpler explanation—with the aid of the three different positions of the busbar 5, shown in FIG. 1, in the insulating profiles 4 arranged above one another. Basically, the installation of an individual busbar 5 in a single insulating profile 4 takes place in an entirely corresponding manner.

First, the busbar 5 is inserted, through the introduction opening 9, into the installation chamber 12 of the insulating profile 4, as shown in FIG. 1. Alternatively, the busbar 5 can also be pushed in on the front side—that is, vertically, on the sectional plane in FIG. 1—into the installation chamber 14.

The busbar 5 then ends up lying in the installation chamber 12 in the position shown in the middle of FIG. 1, and as a result of the holding projections 15, 16, cannot fall out. Alternatively, the busbar can also end up lying, at an incline, against the upper locking lugs 10, so that it falling out from the installation chamber 12 need not be feared, even without holding projections 15, 16.

So that the busbar 5 ends up steep enough and not excessively flat in the installation chamber 12, the height H of the installation chamber 12 can be advantageously selected smaller than the width B of the busbar 5, preferably, 25% and with particular preference, 50% smaller, relative to the width B of the busbar 5. In this way, the risk that the busbar 5 will turn over when introduced into the installation chamber 12 and will come to lie on the lower profile leg 8 in FIG. 2 is reduced.

In order to be able to introduce the busbar 5 in the installation chamber 12, as described above, into an approximate pre-installation position in which the busbar 5 still has some clearance, the height H of the installation chamber 12 can be advantageously larger than the thickness D of the busbar 5, preferably larger than one and one-half times, and with particular preference, larger than twice the thickness D and d of the busbar 5. With the embodiments of the insulating profiles 204 and 304, shown in FIGS. 4 to 7, the largest-possible thickness of a busbar is used as a measure for the height H of the installation chamber 12—that is, the locking lugs 210, 211 and 310, 311, at the furthest distance from the profile bottom 6.

As soon as the busbar 5 is introduced into the installation chamber 12, the busbar 5 is pressed into the receiving chamber 13, manually, with a special pressing tool, or by means of the sliding contact S of the current collector, as indicated in the middle and above in FIG. 1. The pressing tool can advantageously copy the shape of a sliding contact S. If necessary, the pressing tool, instead of the sliding contact S, can also be placed on the current collector vehicle. Upon pressing in the busbar 5, the locking lugs 10, 11 are pressed away in the direction of the profile bottom 6 and onto the profile legs 7, 8 and again snap into their position shown in FIGS. 1 and 2, as soon as the busbar 5 is completely pressed into the receiving chamber 13. Since the profile legs 7, 8 also are elastic, they also yield somewhat during the pressing in of the busbar 5, so that areas of the holding means 10 and 11, 110 and 111, 210 and 211, and 310 and 311, inclined inwards toward the receiving chamber 13, further simplify the insertion of the busbar into the receiving chamber 13.

In order to further facilitate and make the installation more efficient, busbars 4 already inserted into two or more insulating profiles 4 can be simultaneously pressed from the individual installation chambers 12 into the individual receiving chambers 13 in the arrangement of several parallel conducting strands 3, 3′, 3″, shown in FIG. 1. This can, for example, take place in that an already installed current collector vehicle with its individual sliding contacts S meshes into the insulating profiles 4 and when moving past the conductor line 1, presses the inserted busbars from the individual installation chambers 12 into the individual receiving chambers 13.

An alternative conductor line 401, in accordance with the invention, shown in cross-section in FIG. 8, differs essentially from that shown in FIG. 1 in that a third conducting strand 403, shown below in FIG. 8, has a design different from the two upper conducting strands 3, 3′. For the same parts, therefore, the same reference symbols are used, and the statements regarding the conductor line 1 are correspondingly valid.

As can be easily seen in FIG. 8, a lower insulating profile 404 of the lower conducting strand 403 has a cross-section which is different from the insulating profiles 4. The height h4 of the receiving chamber 413 is larger than the height h of the receiving chamber 13, whereas the width w4 of the receiving chamber 413 is smaller than the width w of the receiving chamber 13. The result of this is that the busbar 5 has an excessively large width B for the receiving chamber 413 and therefore cannot be inserted therein. Only one busbar 405 with the width B4 and the thickness B4 passes cleanly into the receiving chamber 413 and is readily held there during operation. The front ends of the profile legs 407, 408, in turn, have holding projections 415, 416.

Conversely, as a result of its thickness D4, which is larger than the height h of the receiving chamber 13 of the insulating profile 4, the busbar 405 cannot be inserted into the receiving chamber 13.

Preferably, this embodiment can be used so as to avoid-already during the installation on-site-a mix-up between the busbars 5 of the conducting strands 3, 3′, provided for the energy transfer, with the busbar 405 of the conductor strand 403, provided as a protective conductor and/or grounding (PE).

Instead of the different rectangular cross-sections of the receiving chambers 13 and 413 and the busbars 5 and 405, shown in FIG. 8, the protection from mix-up can also be ensured in another manner. For example, the busbars provided for the energy transfer can have a rectangular cross-section and the busbars provided for the grounding can have a round or pentagonal, hexagonal, or polygonal cross-section, or vice-versa.

An alternative conductor line 501, in accordance with the invention and shown in cross-section in FIG. 9, essentially differs from the conductor line 401, shown in FIG. 8, in that three individual insulating profiles 4, 4, 404 are not used there, but rather a single insulating profile 504, in accordance with the invention, which holds three conducting strands 503, 503′, and 503″. The design of the installation chambers 12 and 412, the receiving chambers 13 and 413, and the holding means 10, 11 and 410, 411, and the busbars 5, 405, however, corresponds to the embodiment shown in FIG. 8. Otherwise, for the same parts, once again, the same reference symbols are used, and the statements regarding the conductor line 401 are correspondingly valid.

The insulating profile 504 is designed as one piece and has four profile legs 507, 508, 509, and 510, which extend vertically from a common profile bottom plate 511. On their free ends, to the right in FIG. 9, the outer profile legs 507 and 508 have, once again, holding projections 515, 516″. The inner profile legs 509 and 510, on the other hand, form common profile legs for the two adjacent installation chambers 12, 12 and 12 and 412 and receiving chambers 13, 13 and 13 and 413. This means that the front free ends of the profile legs 508 and 509 are designed in the shape of a T and in this way, form holding projections 516, 515′ and 516′, 516″ for the two sides.

The embodiment according to FIG. 9 permits a quick and space-saving installation of the conductor line, since only one insulating profile 504 can be installed. Moreover, as a result of the double use of the inner profile legs 509, 510 as profile legs for two installation chambers 12, 12 and 12 and 412, material and space are economized.

An alternative conductor line 601, in accordance with the invention and shown in cross-section in FIG. 10, essentially differs from the conductor line 501, shown in FIG. 9, in that a receiving chamber 613 there is designed differently for the mix-up-protected insertion of a busbar 605. Otherwise, for the same parts, again, the same reference symbols are used, and the statements regarding the conductor line 501 are correspondingly valid.

The busbar 605 has a moon-shaped cross-section and consists of a carrying layer 605a. preferably made of aluminum, and a sliding layer 605b, preferably made of copper or sliding steel, since aluminum is less suitable as a gliding layer for the sliding contact S, but is cheaper and lighter than copper. A conducting strand 603 with the busbar 605 is again preferably provided as the protective conductor and/or grounding (PE), whereas the two other conducting strands 503, 503′ are provided for the energy transfer.

In order to prevent the busbar 605 with the sliding layer 605b from being inserted upside down into the receiving chamber 613, the receiving chamber 613 has a moon-shaped cross-section, adapted to the busbar 605, which is just as large or only slightly larger.

Furthermore, the differently shaped busbar 605 and the receiving chamber 613 prevent—especially during the installation on-site—the busbars 5 of the conducting strands 503, 503′, provided for the energy transfer, from being mixed up with the busbar 605 of the conductor strand 603, provided as the protective conductor and/or grounding (PE) and from being inserted incorrectly, and vice-versa.

Instead of the moon-shaped design of the busbar 605 and the receiving chamber 613, shown in FIG. 10, it is also possible to select other shapes; for example, a V shape with a corresponding “curvature,” so that the tip of the V is exhibited in the direction of the profile bottom. These shapes, including the one shown in FIG. 10, can also be used with one-piece busbars made of a material to attain a definite coordination of the busbar and the receiving chamber.

Instead of the moon-shaped design of the busbar 605 and the receiving chamber 613, shown in FIG. 10, it is also possible to select other shapes; for example, a V shape with a corresponding “curvature,” so that the tip of the V is exhibited in the direction of the profile bottom. These shapes, including the one shown in FIG. 10, can also be used with one-piece busbars made of a material to attain a definite coordination of the busbar and the receiving chamber.

FIG. 11 shows an enclosed conductor line 701, in accordance with the invention, with three phase conductor strands L1, L2, and L3 and a combined protective grounding conductor strand PE. The phase conductor strands L1, L2, and L3 are formed analogous to conductor strand 3, whereas the protective grounding conductor strand PE is designed in accordance with the conductor strand 403 from FIG. 8. The individual insulating profiles 4 and 404 can be advantageously produced as one piece with the enclosed conductor line profile 704, as indicated in FIG. 11. The enclosed conductor line profile 704 then forms the profile bottom of the individual conducting strands L1, L2, L3, and PE.

In a non-depicted embodiment, the holding means 10 and 11, 110 and 111, 210 and 211, 310 and 311, and 410 and 411 can advantageously run continuously through the entire length of the insulating profiles 4, 104, 204, 304, and 404. Alternatively, the holding means 10 and 11, 110 and 111, 210 and 211, 310 and 311, and 410 and 411 can also be advantageously interrupted or be arranged at specific sites on the profile legs 7, 8, preferably at the same distance from one another. The holding means 10 and 11, 110 and 111, 210 and 211, and 310 and 311 of the profile legs 7, 8 and 407, 408, opposite one another, can then advantageously lie directly opposite one another or be in a longitudinal direction L, staggered relative to one another.

### LIST OF REFERENCE SYMBOLS

1 Conductor line
2 Carrying structure
3, 3′, 3″ Conducting strands
4 U-shaped insulating profile
5 Busbar
6 Profile bottom
7, 8 Profile legs
9 Introduction opening
10, 11 Locking lugs (Holding means)
12 Installation chamber
13 Receiving chamber
14 Installation opening
15, 16 Holding projections
17, 18 Sliding surfaces of the locking lugs
19, 20 Locking surfaces of the locking lugs
104 Alternative insulating profile
110, 111 Locking bars (Holding means)
115, 116 Alternative holding projections
204 Alternative insulating profile
210, 211 Sawtooth-shaped locking profile (Holding means)
210a, 211a Lowermost locking lugs
210b, 211b Middle locking lugs
205 Flat busbar
304 Alternative insulating profile
310, 311 Stepped sawtooth-shaped locking profile (Holding means)
310a, 311a Lowermost locking lugs
310b, 311b Middle locking legs
401 Alternative conductor line with grounding-conducting strand
403 Conducting strand for grounding
404 U-shaped grounding-insulating profile
405 Busbar for grounding
406 Profile bottom grounding-insulating profile
407, 408 Profile legs grounding-insulating profile
409 Introduction opening grounding-insulating profile
410, 411 Locking lugs (Holding means) grounding-insulating profile
412 Installation chamber grounding-insulating profile
413 Receiving chamber grounding-insulating profile
414 Installation opening grounding-insulating profile
415, 416 Holding projections grounding-insulating profile
501 Alternative conductor line with grounding-conducting strand
503, 503′, 503″ Conducting strands
504 Alternative insulating profile
507, 508 Outer profile leg
509, 510 Inner profile leg
511 Common profile bottom plate
515, 516″ Holding projections outer profile leg
515′, 515″, 516′, 516″ T-shaped holding projections inner profile leg
601 Alternative conductor line with grounding-conducting strand
603 Conducting strand for grounding
604 Alternative insulating profile
605 Alternative moon-shaped busbar
605a Carrying layer moon-shaped busbar
605b Sliding layer moon-shaped busbar
606 Sickle-shaped profile bottom
613 Moon-shaped receiving chamber
701 Enclosed conductor line
704 Insulating profile for enclosed conductor line
B, B4 Width of the busbars 5, 205, and 412
d Thickness of the flatter busbar 205
D, D4 Thickness of the thicker busbars 5 and 405
H, h4 Height of the receiving chamber 13 and 413
H, H4 Height of the receiving chambers 12 and 412
w, w4 Width of the receiving chambers 13 and 413
W, W4 Width of the installation chambers 12 and 412
I Inner space
L Longitudinal direction insulating profile and conductor line
L1, L2, L3 Conductor strand for the phase conductor
PE Conductor strand for the protective conductor and the grounding/neutral conductor
S Sliding contact current collector

1-25. (canceled)

26. Insulating profile for a conductor line with at least two profile legs, extending into a longitudinal direction of the insulating profile, which surround at least one receiving chamber for the holding of a busbar, wherein the receiving chamber has an installation opening, extending in the longitudinal direction, wherein on the receiving chamber, there is an adjoining installation chamber with an introduction opening, extending in the longitudinal direction, which is located between the profile legs.

27. The insulating profile of claim 26, wherein holding means for holding of the busbar in the receiving chamber is provided between the receiving chamber and the installation chamber.

28. The insulating profile of claim 27, wherein the holding means is located on at least one of the profile legs.

29. The insulating profile of claim 28, wherein the holding means is interrupted in the longitudinal direction.

30. The insulating profile of claim 28, wherein the holding means is located on both profile legs.

31. The insulating profile of claim 30, wherein the holding means, located on profile legs opposite one another, is located in the longitudinal direction, staggered, relative to one another.

32. The insulating profile of claim 27, wherein the holding means, as seen from the installation chamber, has at least one sliding surface, inclined from the profile legs toward the receiving chamber.

33. The insulating profile of claim 27, wherein the holding means, as seen from the receiving chamber, has at least one holding surface, which projects substantially vertically from the profile legs.

34. The insulating profile of claim 27, wherein the holding means has locking lugs, which become shorter and shorter from the installation chamber toward the receiving chamber.

35. The insulating profile of claim 27, wherein the holding means has a sawtooth-shaped design.

36. The insulating profile of claim 27, wherein the holding means and/or the insulating profile are elastic.

37. The insulating profile of claim 26, wherein on the profile legs, preferably inward directed holding projections are provided in the area of the installation chamber.

38. The insulating profile of claim 26, wherein the width of the receiving chamber substantially corresponds to the width of the busbar or is slightly larger.

39. The insulating profile of claim 26, wherein the height of the receiving chamber substantially corresponds to the thickness of the busbar or is slightly larger.

40. The insulating profile of claim 26, wherein the height of the installation chamber is smaller than the width of the busbar, is preferably smaller than one-fourth and with particular preference, smaller than half of the width of the busbar.

41. The insulating profile of claim 26, wherein the height of the installation chamber is larger than the thickness of the busbar, is preferably larger than one and one-half times, and with particular preference, larger than twice the thickness of the busbar.

42. The insulating profile of claim 26, wherein the insulating profile has several receiving chambers.

43. The insulating profile of claim 42, wherein at least one of the receiving chambers has a shape different from that of the other receiving chambers.

44. A conductor line with at least one insulating profile of claim 26, and at least one electrically conductive busbar inserted therein.

45. The conductor line of claim 44, wherein the conductor line has a plurality of insulating profiles, which are preferably located next to one another.

46. The conductor line of claim 45, wherein at least one receiving chamber has a shape different from that of the other receiving chambers, and wherein the busbars are adapted to the shape of the individual receiving chambers.

47. The conductor line of claim 44, wherein the busbar and the receiving chamber are adapted to one another in their shape, outer contour, and/or cross-section for mix-up protection of the insertion of the busbar into the receiving chamber.

48. A method for producing a conductor line of claim 44, comprising the following steps:
a) inserting, pulling in, or pushing in at least one busbar into at least one installation chamber;
b) pressing in the busbar from the installation chamber into the receiving chamber.

49. The method of claim 48, wherein the pressing in of the busbar takes place, in step b), by means of a pressing tool or takes place, by means of a sliding contact of a current collector, conducted along the conductor line.

50. The method of claim 48, wherein at least two busbars are simultaneously pressed into the individual receiving chamber.
